(19) United States
(12) Patent Application Publication
(10) Pub. No.: US 2005/0275790 A1
(43) Pub. Date: Dec. 15, 2005

(54) Manufacturing method of liquid crystal substrate and manufacturing device of liquid crystal substrate

(75) Inventor: Yuji Iwata, Suwa-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/133,203

(22) Filed: May 20, 2005

(30) Foreign Application Priority Data
Jun. 10, 2004 (JP) 2004-172542

(51) Int. Cl. G02F 1/13

(52) U.S. Cl. 349/187

(57) ABSTRACT

Aspects of the invention can include an applying step for applying an orientation film ink to a plurality of substrates and so on that are removably provided on a pallet base having a uniform thickness and housed in a lattice frame of matrix form, a removing step for removing the lattice frame from the pallet base, and a heating step for heating the plurality of substrates and so on through the pallet base. The orientation film ink respectively applied to the substrates and so on can be dried by the uniform heat through the pallet base. Accordingly, the invention can improve yield.

### BACKGROUND

Aspects of the invention can relate to a manufacturing method of a liquid crystal substrate and a manufacturing device of a liquid crystal substrate. Particularly, the invention can relate to a manufacturing method of a liquid crystal substrate and a manufacturing device of a liquid crystal substrate which can improve the yield.

A related art method applies an orientation film ink to a substrate by an ink jet method and then forms an orientation film on the substrate, in order to manufacture a liquid crystal substrate. See, for example, Japanese Unexamined Patent Publication No. H3-249623. FIG. 5 is a plane view explaining the related art manufacturing method of a liquid crystal substrate. FIG. 6 is a cross sectional view cut along the line A-A′ shown in FIG. 5. In these figures, a heating plate 10 has a function to carry out heating by drying the orientation film ink applied to substrates 30₁ through 30₂₅ arranged in matrix form to form the orientation film.

A pallet 20 can be formed with housing units 21₁ through 21₂₅ in matrix form, and formed on the heating plate 10. In these housing units 21₁ through 21₂₅, the substrates 30₁ through 30₂₅ are respectively housed in a positioned state. An ink jet head 40 is formed movably on the pallet 20, and the orientation film ink 50 is discharged to the substrates 30₁ through 30₂₅ by the ink jet method.

In the above-described configuration, the ink jet head 40 is movably controlled, and sequentially discharges an orientation film ink 50 to the substrates 30₁ through 30₂₅. Therefore, to the respective substrates 30₁ through 30₂₅, the orientation film ink 50 is applied. Next, as described in FIG. 7 and FIG. 8, the heating plate 10 is switched on, and through the pallet 20, the substrates 30₁ through 30₂₅ are heated. Therefore, the orientation film ink 50 respectively applied to the substrates 30₁ through 30₂₅ is dried, and then, on the substrates 30₁ through 30₂₅, the orientation film is formed. After the substrates 30₁ through 30₂₅ are dried, they become liquid crystal substrates.

### SUMMARY

In the related art manufacturing method of a liquid crystal substrate, as described in FIG. 7, due to nonuniformity of the thickness of the cross section of the pallet 20, the thermal conductivity from the heating plate 10 also becomes nonuniform. Accordingly, in the related art manufacturing method of a liquid crystal substrate, as described in FIG. 8, due to nonuniformity of the temperature distribution of substrates 30₁ through 30₂₅, dry nonuniformity of an orientation film ink occurs and can cause a problem of poor yield.

Aspects of the invention can provide a manufacturing method of a liquid crystal substrate and a manufacturing device of a liquid crystal substrate which can improve the yield. The invention can include, an applying step for applying an orientation film ink to a plurality of substrates that are removably provided on a pallet base having a uniform thickness and housed in a lattice frame of matrix form, a removing step for removing the lattice frame from the pallet base, and a heating step for heating the plurality of substrates through the pallet base.

Moreover, the invention can include an applying device for applying an orientation film ink to a plurality of substrates that are removably provided on a pallet base having a uniform thickness and housed in a lattice frame of matrix form, a removing device for removing the lattice frame from the pallet base, and a heating device for heating the plurality of substrates through the pallet base.

According to an aspect of the invention, by applying an orientation film ink to a plurality of substrates that are removably provided on a pallet base having a uniform thickness and housed in a lattice frame of matrix form, by removing the lattice frame from the pallet base, and by heating the plurality of substrates through the pallet base, due to the uniform thickness of the pallet base, the temperature distribution of a plurality of the substrates become uniform and dry nonuniformity of the orientation film ink is prevented, therefore it is effective for improving the yield.

### BRIEF DESCRIPTION OF THE DRAWINGS

The invention will be described with reference to the accompanying drawings, wherein like numerals reference like elements, and wherein:

FIG. 1 is a plane view showing the configuration of an exemplary embodiment of the invention;

FIG. 2 is a cross sectional view cut along the line B-B′ shown in FIG. 1;

FIG. 3 is a cross sectional view explaining the heating movement of the exemplary embodiment;

FIG. 4 is a plane view explaining the heating movement of the exemplary embodiment;

FIG. 5 is a plane view explaining the related art manufacturing method of the liquid crystal substrate;

FIG. 6 is a cross sectional view cut along the line A-A′ shown in FIG. 5;

FIG. 7 is a cross sectional view explaining the heating movement of the related art manufacturing method of the liquid crystal substrate; and

FIG. 8 is a plane view explaining the heating movement of the related art manufacturing method of the liquid crystal substrate.

### DETAILED DESCRIPTION OF EMBODIMENTS

An exemplary embodiment of a manufacturing method of a liquid crystal substrate and a manufacturing device of a liquid crystal substrate of the invention will now be described in detail with reference to the accompanying drawings. Additionally, it should be understood that the invention will not be limited by this exemplary embodiment.

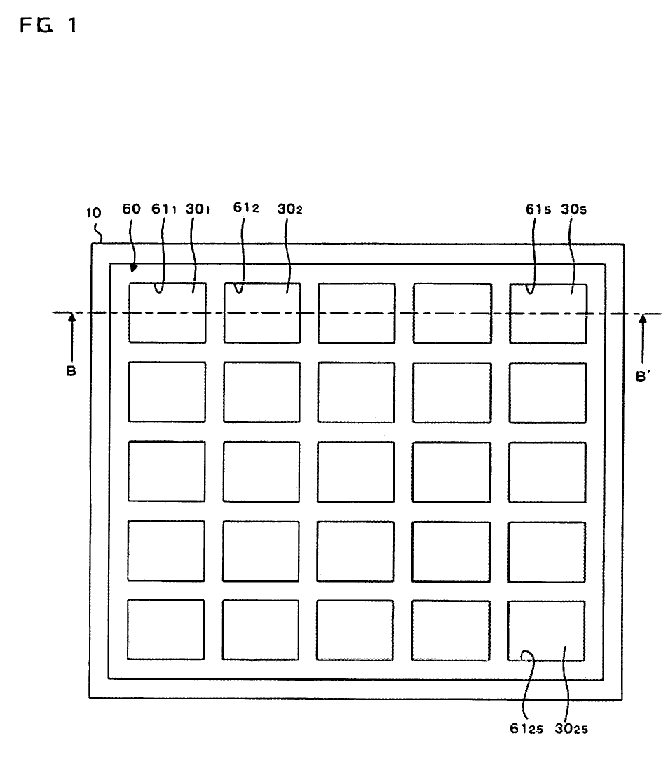

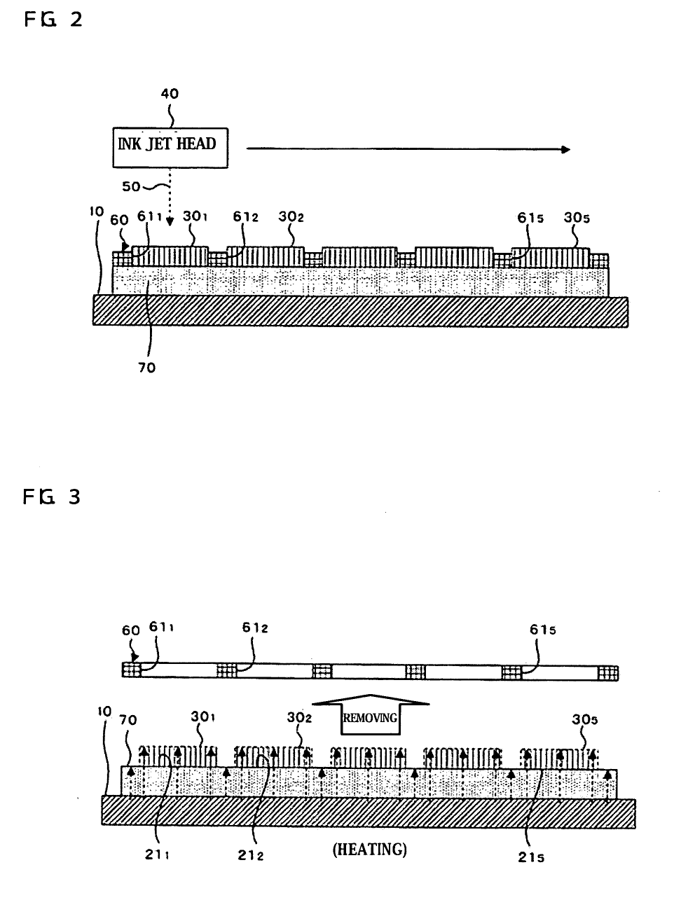

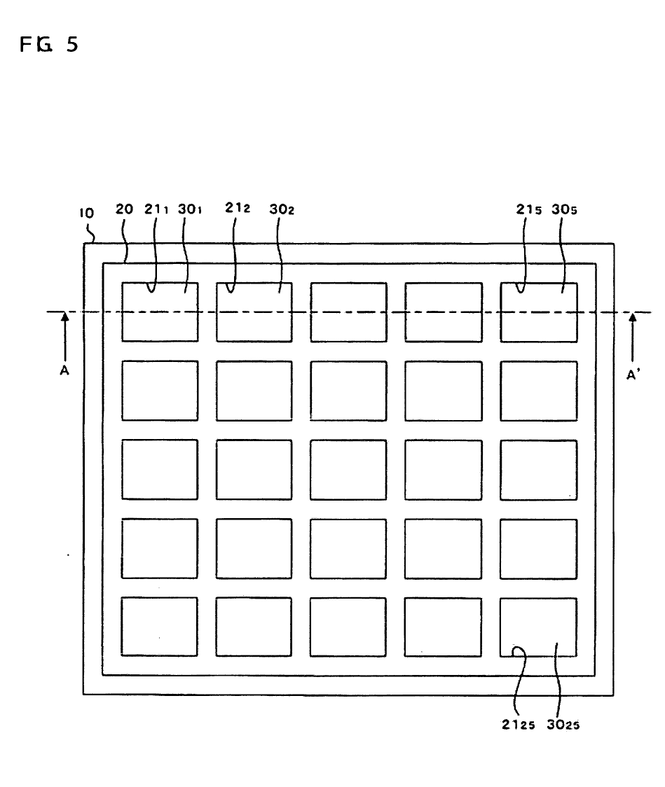

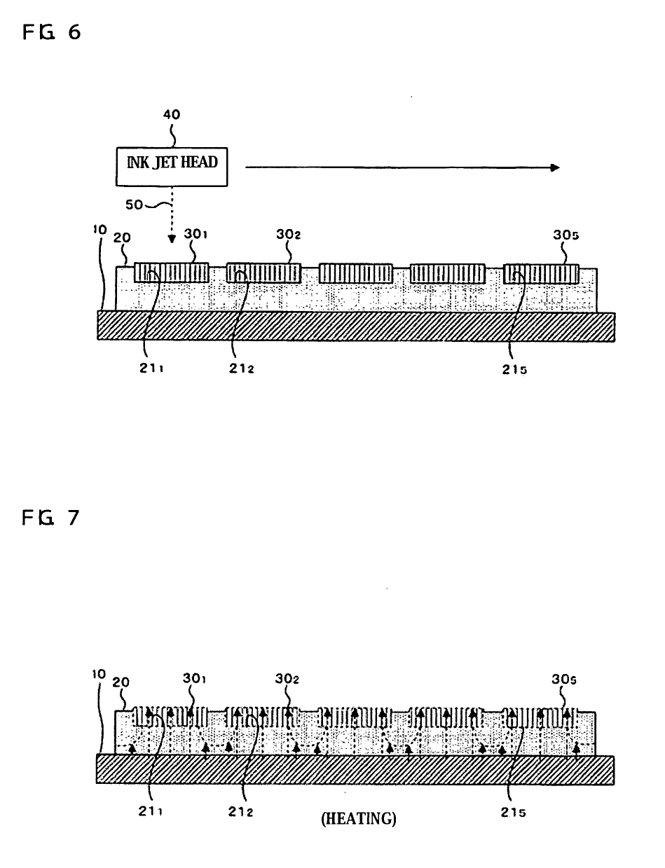

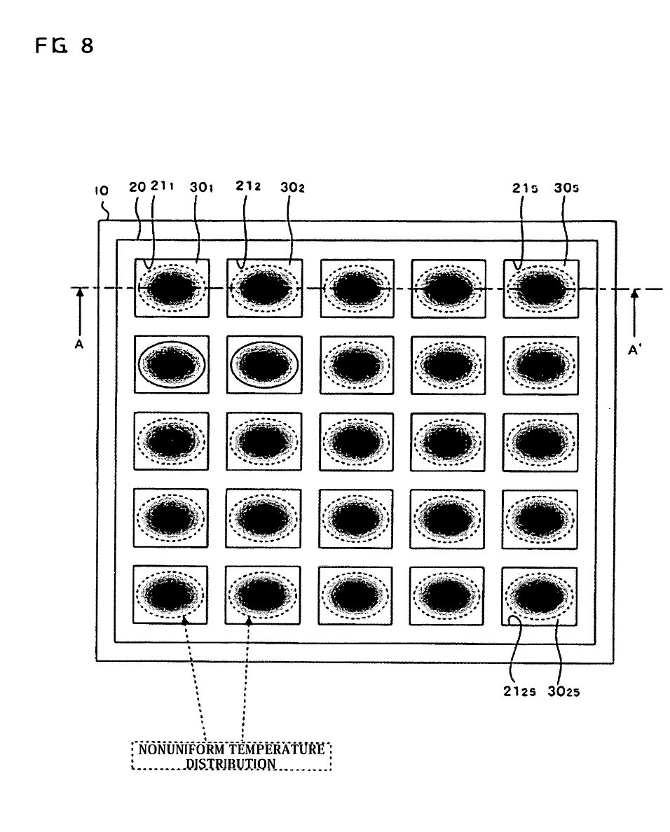

FIG. 1 is a plane view showing the configuration of an exemplary embodiment of the invention. FIG. 2 is a cross sectional view cut along the line B-B′ shown in FIG. 1. A manufacturing method of a liquid crystal substrate and a manufacturing device of a liquid crystal substrate will be described hereunder. In FIG. 1 and FIG. 2, parts which correspond to those of FIG. 5 and FIG. 6 will be indicated by the same reference numerals, and the detailed description will be omitted. In FIG. 1 and FIG. 2, in lieu of a pallet 20 described in FIG. 5 and FIG. 6, a lattice frame 60 and a pallet base 70 are provided.

The lattice frame 60 and the pallet base 70 are composed by materials with high thermal conductivity, such as aluminum, and form a pallet. The lattice frame 60 is a lattice-shaped frame, and is removable with respect to the pallet base 70. The lattice frame 60 is formed with housing units 61₁ through 61₂₅ in matrix form, and is provided on the pallet base 70 (refer to FIG. 2). The pallet base 70 is a plate member having uniform thickness. In these housing units 61₁ through 61₂₅, substrates 30₁ through 30₂₅ are respectively housed in a positioned state.

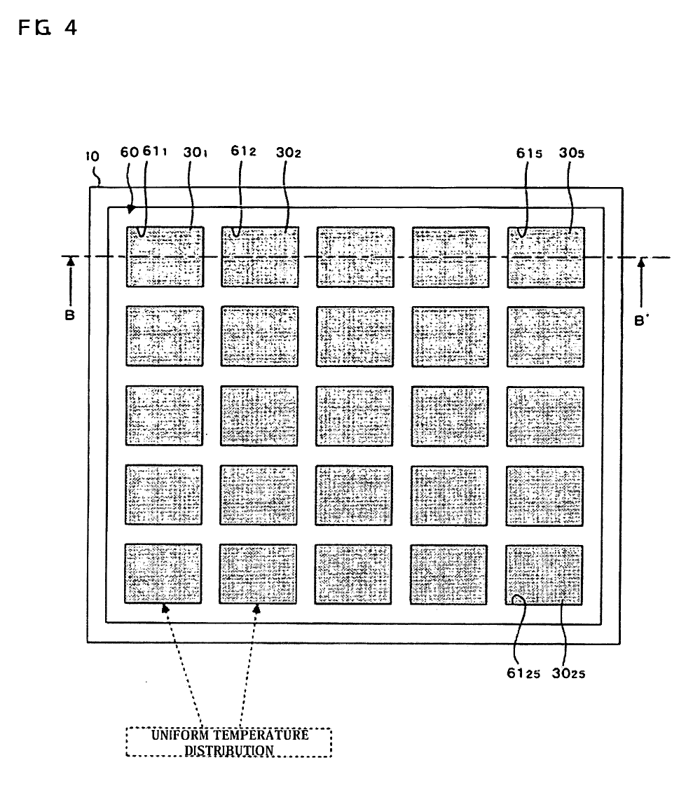

In the above-described configuration, as described in FIG. 2, an ink jet head 40 is movably controlled, and sequentially discharges an orientation film ink 50 to the substrates 30₁ through 30₂₅. Therefore, to the respective substrates 30₁ through 30₂₅, the orientation film ink 50 is applied. Next, as described in FIG. 3, by a driving device (not shown), the lattice frame 60 is removed from the pallet base 70.

Next, when a heating plate 10 is switched on, through the pallet base 70, the substrates 30₁ through 30₂₅ are heated. Accordingly, the orientation film ink 50 respectively applied to the substrates 30₁ through 30₂₅ are dried, and then, on the substrates 30₁ through 30₂₅, the orientation film is formed. After the substrates 30₁ through 30₂₅ are dried, they become liquid crystal substrates.

Here, in the exemplary embodiment, due to uniform thickness of the pallet base 70, the thermal conductivity from the heating plate 10 is also uniform. Accordingly, in the exemplary embodiment, as described in FIG. 4, the temperature distribution of the substrates 30₁ through 30₂₅ are uniform, and the dry nonuniformity of the orientation film ink is hard to occur, therefore improving the yield.

In addition, in the exemplary embodiment, by making the thermal conductivity of the pallet base 70 higher than the thermal conductivity of the lattice frame 60, it can be a configuration example which makes the dry effectiveness of the substrates 30₁ through 30₂₅ high.

As described above, the manufacturing method of the liquid crystal substrate and the manufacturing device of the liquid crystal substrate of the invention are useful for preventing or reducing the dry nonuniformity of the orientation film ink applied to the substrate.

1. A manufacturing method of a liquid crystal substrate, comprising:
applying an orientation film ink to a plurality of substrates that are removably provided on a pallet base having a uniform thickness and housed in a lattice frame of matrix form;
removing the lattice frame from the pallet base; and
heating the plurality of substrates through the pallet base.

2. The manufacturing method of a liquid crystal substrate according to claim 1,
a thermal conductivity of the pallet base being higher than a thermal conductivity of the lattice frame.

3. A manufacturing device of a liquid crystal substrate, comprising:
an applying device that applies an orientation film ink to a plurality of substrates that are removably provided on a pallet base having a uniform thickness and housed in a lattice frame of matrix form;
a removing device that removes the lattice frame from the pallet base; and
a heating device that heats the plurality of substrates through the pallet base.

4. The manufacturing device of a liquid crystal substrate according to claim 3,
a thermal conductivity of the pallet base being higher than a thermal conductivity of the lattice frame.
